(19) United States
(12) Patent Application Publication
(10) Pub. No.: US 2025/0271218 A1
(43) Pub. Date: Aug. 28, 2025

(54) HEAT TRANSFER PIPE, HEAT EXCHANGER, PIPE EXPANDING TOOL, PIPE EXPANDING DEVICE, METHOD FOR CONNECTING HEAT TRANSFER PIPE AND PIPE, AND METHOD FOR MANUFACTURING HEAT EXCHANGER

(71) Applicant: Mitsubishi Electric Corporation, Chiyoda-ku, Tokyo (JP)

(72) Inventors: Nobuhiro TACHIBANA, Chiyoda-ku, Tokyo (JP); Takuya SAITO, Chiyoda-ku, Tokyo (JP); Hiroshi CHIMURA, Chiyoda-ku, Tokyo (JP)

(73) Assignee: Mitsubishi Electric Corporation, Chiyoda-ku, Tokyo (JP)

(21) Appl. No.: 18/856,835

(22) PCT Filed: May 2, 2023
(86) PCT No.: PCT/JP2023/017110

§ 371 Date: Oct. 14, 2024

(30) Foreign Application Priority Data
May 16, 2022 (JP) 2022-080337

(51) Int. Cl. F28F 1/00; B21D 53/06

(52) U.S. Cl. CPC F28F 1/006; B21D 53/06

(57) ABSTRACT

A heat transfer pipe has a flared portion having a shape of spherical zone with an inner diameter at the distal end being larger than an inner diameter at the proximal end. The flared portion is disposed with another pipe that is a target of coupling being disposed through the flared portion. The flared portion is coupled to the other pipe with a brazing material filling a gap between the other pipe and an inner wall of the flared portion.

### TECHNICAL FIELD

The present disclosure relates to a heat transfer pipe, a heat exchanger, a pipe expanding tool, a pipe expanding device, a method of coupling a heat transfer pipe to another pipe, and a method of fabricating a heat exchanger.

### BACKGROUND ART

Some heat exchangers including heat transfer pipes are provided with bent pipes. The bent pipes are coupled to the end parts of the heat transfer pipes and brazed to the end parts, so as to connect the heat transfer pipes to each other. Some of these heat exchanges include heat transfer pipes having flared portions at the end parts of the heat transfer pipes into which bent pipes are inserted. The flare portions receive a brazing material during a brazing step in order to prevent the brazing material from dripping onto the heat transfer pipes.

For example, Patent Literature 1 discloses a heat exchanger including heat transfer pipes having flared portions at the end parts. These flared portions each have a funnel-shaped bottom and a cylindrical wall surrounding the bottom. In the heat exchanger disclosed in Patent Literature 1, the bent pipes disposed in the end parts of the heat transfer pipes and the cylindrical walls of the flared portions are provided with ring-shaped brazing members therebetween. The ring-shaped brazing members are then melted to braze the bent pipes to the end parts. The ring-shaped brazing members are each surrounded by the cylindrical wall and received by the bottom, so that the heat exchanger disclosed in Patent Literature 1 is less likely to suffer from dripping of a brazing material.

### CITATION LIST

### Patent Literature

Patent Literature 1: International Publication No. WO 2017/168747

### SUMMARY OF INVENTION

### Technical Problem

A typical flared portion is formed by expanding the end part of a heat transfer pipe. The flared portions of the heat exchanger disclosed in Patent Literature 1, however, have such a size as to accommodate the ring-shaped brazing members. If these flared portions in Patent Literature 1 are formed through pipe expansion, the resulting flared portions have a reduced thickness because of a high percentage of pipe expansion. Such thin flared portions may fracture during formation.

An objective of the present disclosure, which has been accomplished to solve the above problem, is to provide a heat transfer pipe, a heat exchanger, a pipe expanding tool, a pipe expanding device, a method of coupling a heat transfer pipe to another pipe, and a method of fabricating a heat exchanger, which can avoid fracture of flared portions during formation and dripping of a brazing material.

### Solution to Problem

In order to achieve the above objective, a heat transfer pipe according to the present disclosure includes a flared portion having a shape of spherical zone with an inner diameter at the distal end being larger than an inner diameter at the proximal end. The flared portion is disposed with another pipe that is a target of coupling being disposed through the flared portion. The flared portion is coupled to the other pipe with a brazing material filling a gap between the other pipe and an inner wall of the flared portion.

### Advantageous Effects of Invention

The flared portion according to the present disclosure has a shape of spherical zone with an inner diameter at the distal end being larger than an inner diameter at the proximal end, and can prevent damage caused by formation from being concentrated at the distal end. This flared portion is thus less likely to fracture. The flared portion, which has the above-mentioned shape of spherical zone, defines a gap broadened toward the distal end against the pipe that is the target of coupling. This flared portion can readily receive a brazing material. The flared portion can thus avoid dripping of a brazing material.

### BRIEF DESCRIPTION OF DRAWINGS

FIG. 1A is a perspective view of a heat exchanger including heat transfer pipes according to Embodiment 1 of the present disclosure;

FIG. 1B is a sectional view of the heat exchanger including the heat transfer pipes according to Embodiment 1 of the present disclosure;

FIG. 1C is a right side view of the heat exchanger including the heat transfer pipes according to Embodiment 1 of the present disclosure;

FIG. 2 is a perspective view of the heat transfer pipe according to Embodiment 1 of the present disclosure;

FIG. 3 is a sectional view taken along the line III-III of FIG. 2;

FIG. 4 is an enlarged view of the region IV of FIG. 3;

FIG. 5 is a flowchart illustrating a method of fabricating the heat exchanger including the heat transfer pipes according to Embodiment 1 of the present disclosure;

FIG. 6 is a side view of a pipe expanding tool used in the method of fabricating the heat exchanger including the heat transfer pipes according to Embodiment 1 of the present disclosure;

FIG. 7 is an enlarged view around the tip of the pipe expanding tool used in the method of fabricating the heat exchanger including the heat transfer pipes according to Embodiment 1 of the present disclosure;

FIG. 8 illustrates a result of simulation for a distribution of damage values at the heat transfer pipe according to Embodiment 1 of the present disclosure during formation of a flared portion of the heat transfer pipe;

FIG. 9 is a graph illustrating a relationship between an outer diameter of the heat transfer pipe and a damage value during formation of the flared portion;

FIG. 10 is a graph illustrating a relationship between an outer diameter of the heat transfer pipe and an increase in equivalent strain during formation of the flared portion;

FIG. 11 illustrates a result of simulation for a distribution of damage values at the heat transfer pipe in the case of pipe expansion with a pipe expanding tool of a truncated cone type;

FIG. 12 is a front view of a heat transfer pipe according to a reference example in the case of pipe expansion with the pipe expanding tool of a truncated cone type;

FIG. 13 illustrates a result of simulation for a distribution of damage values at the heat transfer pipe in the case of pipe expansion with the pipe expanding tool having a spherical segment according to Embodiment 1 of the present disclosure;

FIG. 14 is a front view of a heat transfer pipe while being expanded by the pipe expanding tool having a spherical segment according to Embodiment 1 of the present disclosure;

FIG. 15 is a graph illustrating a relationship between a level of pipe expansion and an equivalent stress during formation of the flared portion;

FIG. 16 is a front view of a heat transfer pipe in which the pipe expanding tool having a spherical segment according to Embodiment 1 of the present disclosure is squeezed by a distance equal to or longer than a target distance;

FIG. 17 is a sectional view of the heat transfer pipe provided with brazing members in a brazing step of the method of fabricating the heat exchanger including the heat transfer pipes according to Embodiment 1 of the present disclosure;

FIG. 18 is a sectional view of the heat transfer pipe after formation of fillets in the brazing step of the method of fabricating the heat exchanger including the heat transfer pipes according to Embodiment 1 of the present disclosure;

FIG. 19 is a side view of a pipe expanding tool used in a method of fabricating a heat exchanger including heat transfer pipes according to Embodiment 2 of the present disclosure;

FIG. 20 is an enlarged view around the tip of the pipe expanding tool used in the method of fabricating the heat exchanger including the heat transfer pipes according to Embodiment 2 of the present disclosure;

FIG. 21 is a perspective view of a modification of the heat transfer pipe according to Embodiment 1 of the present disclosure; and

FIG. 22 is a side view of a modification of the pipe expanding tool used in the method of fabricating the heat exchanger including the heat transfer pipes according to Embodiment 1 of the present disclosure.

### DESCRIPTION OF EMBODIMENTS

The following describes a heat transfer pipe, a heat exchanger, a pipe expanding tool, a pipe expanding device, a method of coupling a heat transfer pipe to another pipe, and a method of fabricating a heat exchanger according to embodiments of the present disclosure, with reference to the accompanying drawings. In the drawings, the components identical or corresponding to each other are provided with the same reference symbol. The drawings are provided with an orthogonal coordinate system XYZ, in which the Z axis corresponds to the vertical direction and the XY plane corresponds to the horizontal plane when the pipe axis direction of heat transfer pipes are vertically oriented. The following description refers to this coordinate system as required.

### Embodiment 1

A heat transfer pipe according to Embodiment 1 has a bowl-shaped flared portion.

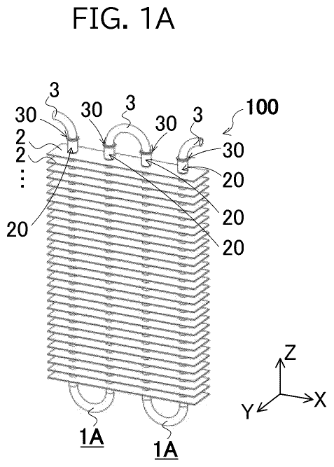

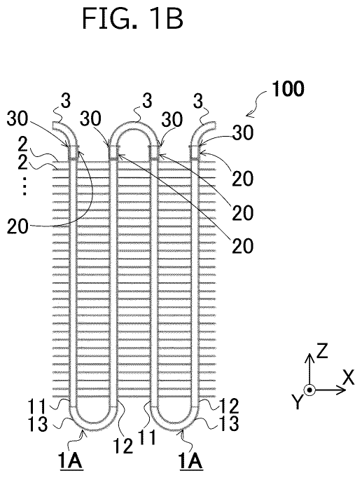

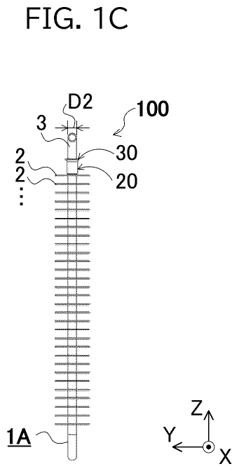

This flared portion is formed by expanding the end part of the heat transfer pipe with a pipe expanding tool of a spherical segment type, in order to avoid fracture during formation. A structure of a heat exchanger that includes such heat transfer pipes as above is described below with reference to FIGS. 1A to IC.

FIG. 1A is a perspective view of a heat exchanger 100 including heat transfer pipes 1A according to Embodiment 1. FIG. 1B is a sectional view of the heat exchanger 100. FIG. 1C is a right side view of the heat exchanger 100. FIGS. 1A and 1B each illustrate not all but only a part of the heat exchanger 100, in order to facilitate an understanding.

As illustrated in FIGS. 1A to 1C, the heat exchanger 100 includes multiple heat transfer pipes 1A, and multiple fins 2 fixed to the heat transfer pipes 1A.

Each of the heat transfer pipes 1A has a shape of circular pipe to allow fluid for heat exchange, such as refrigerant, to flow therethrough. The heat transfer pipe 1A has grooves extending helically, that is, spiral grooves on the inner wall, which are not illustrated in FIGS. 1A to IC. The heat transfer pipe 1A thus causes refrigerant, which is flowing therethrough, to be stirred.

As illustrated in FIG. 1B, each of the heat transfer pipes 1A includes a pair of linear segments 11 and 12 made of linearly extending circular pipes, and a curved segment 13 having a U-shape that connects one ends of the linear segments 11 and 12 to each other, in order to circulate the refrigerant inside the heat exchanger 100. In short, the heat transfer pipe 1A is a so-called hairpin tube. The heat transfer pipe 1A is oriented such that the linear segments 11 and 12 extend in the vertical direction. Upper end parts of the linear segments 11 and 12 of the heat transfer pipes 1A are coupled with U-shaped bent pipes 3. The heat transfer pipes 1A are thus connected to each other. This structure allows the refrigerant to travel between the heat transfer pipes 1A.

The heat transfer pipes 1A are made of a metal having a high thermal conductivity, such as pure copper, copper alloy, pure aluminum, or aluminum alloy, so as to facilitate heat conduction from the refrigerant traveling inside the heat transfer pipes 1A. The heat transfer pipes 1A are provided with multiple fins 2 for exchange of the heat received at the heat transfer pipes 1A.

The fins 2 are made of a metal having a high thermal conductivity, like the heat transfer pipes 1A, so as to improve the heat radiation performance. The fins 2 each have a flat plate shape, as illustrated in FIGS. 1A to 1C, which also contributes to improvement of the heat radiation performance. The fins 2 are oriented such that their main surfaces face the vertical direction, that is, the main surfaces are orthogonal to the pipe axes of the heat transfer pipes 1A. The fins 2 are joined to the heat transfer pipes 1A. The fins 2 thus receive heat from the heat transfer pipes 1A and radiate the heat to the ambient air.

The fins 2 are arranged with a certain interval in the vertical direction.

These fins 2 allow the air to pass through the gaps between the fins 2 and can thus improve the efficiency of heat exchange.

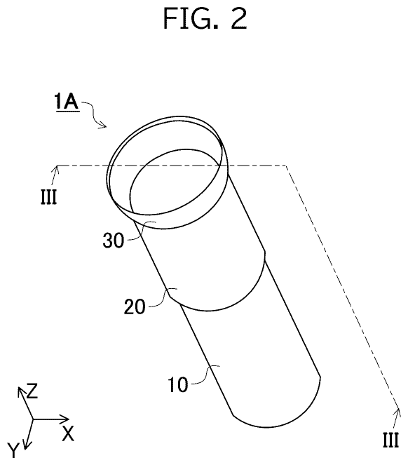

As described above, the heat transfer pipes 1A are connected to each other with the bent pipes 3. The bent pipes 3 are joined to the heat transfer pipes 1A by brazing. The brazing may unintentionally cause a brazing material to drip onto the heat transfer pipes 1A or the fins 2. To avoid dripping of a brazing material, the heat exchanger 100 has flared portions 30 at the upper end parts of the heat transfer pipes 1A. The following describes a structure of the heat transfer pipe 1A including the flared portions 30, with reference to FIGS. 2 to 4.

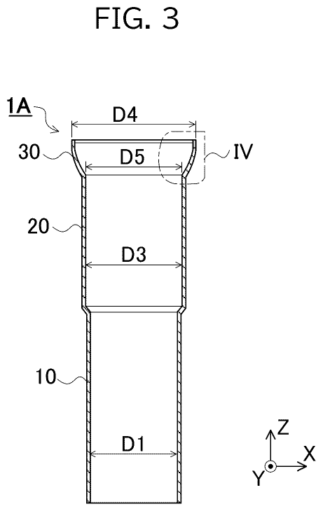

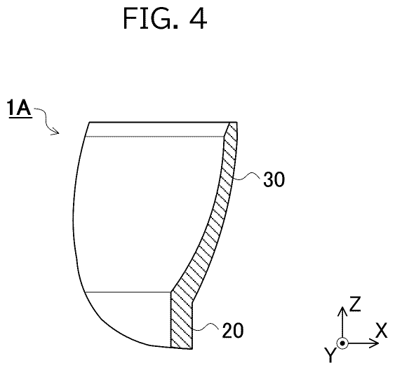

FIG. 2 is a perspective view of the heat transfer pipe 1A according to Embodiment 1. FIG. 3 is a sectional view taken along the line III-III of FIG. 2. FIG. 4 is an enlarged view of the region IV of FIG. 3. FIGS. 2 and 3 each illustrate only one of the upper end parts of the heat transfer pipes 1A illustrated in FIGS. 1A to 1C, in order to facilitate an understanding.

As illustrated in FIGS. 2 to 4, each of the upper end parts of the heat transfer pipes 1A has a pipe retaining portion 20 and a flared portion 30 for connection to the above-described bent pipe 3.

The pipe retaining portion 20 retains the bent pipe 3 to be inserted, which is illustrated in FIGS. 1A to 1C. In detail, the pipe retaining portion 20 has an inner diameter D3 larger than an inner diameter D1 of a main portion 10 of the heat transfer pipe 1A, as illustrated in FIG. 3. This inner diameter D3 is larger than an outer diameter D2 of the bent pipe 3 illustrated in FIG. 1C. Specifically, the inner diameter D3 is larger than the outer diameter D2 of the bent pipe 3 by a difference corresponding to tolerances, so as to allow the pipe retaining portion 20 to receive the bent pipe 3 having the outer diameter D2. For example, the inner diameter D3 is larger by a difference corresponding to dispersions of the curvature and the outer diameter D2 of the bent pipe 3. The pipe retaining portion 20 thus allows the end part of the bent pipe 3 to be inserted therein, and retains the inserted end part of the bent pipe 3.

The pipe retaining portion 20 is welded to the inserted end part of the bent pipe 3, although this configuration is not illustrated. In detail, the pipe retaining portion 20 is brazed to the end part. The pipe retaining portion 20 thus stabilizes the inserted bent pipe 3. The pipe retaining portion 20 has an end or an upper end continuous to the flared portion 30, as illustrated in FIGS. 2 to 4.

The flared portion 30 has a bowl shape so as to avoid dripping of a brazing material in the above-mentioned brazing step. In detail, the flared portion 30 has a shape of spherical zone with the inner diameter at one end being larger than the inner diameter at the other end. The flared portion 30 is oriented such that the other end having the smaller inner diameter is adjacent to the pipe retaining portion 20, so as to gather a brazing material melted during the brazing step. As illustrated in FIG. 3, the flared portion 30 has a shape of spherical zone with an inner diameter D4 at the upper end being larger than an inner diameter D5 at the lower end. The flared portion 30 thus has an inclination increasing toward the upper end.

This specification defines a spherical zone as a part of a spherical surface existing between two parallel planes that intersect the spherical surface. Examples of the spherical surface include not only surfaces of spheres but also surfaces of elliptical spheres, such as prolate spheres and oblate spheres. The spherical zone may thus have a circular, elliptical, elongated circular, or flattened circular contour, when viewed in the direction orthogonal to the two parallel planes that intersect the spherical surface.

The flared portion 30 has the inner diameter D5 at the lower end equal to the above-mentioned inner diameter D3 of the pipe retaining portion 20. Due to this configuration, the bent pipe 3 is disposed through the flared portion 30 when the end part of the bent pipe 3 is inserted into the pipe retaining portion 20. The flared portion 30 has the inner diameter D4 at the upper end larger than the inner diameter D5 at the lower end, as described above, and can thus readily receive a melted brazing material during the step of brazing the pipe retaining portion 20 to the bent pipe 3. This structure can avoid dripping of a brazing material.

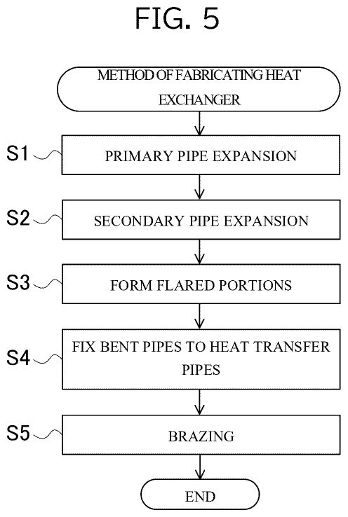

That is, the flared portion 30 has a shape of spherical zone with the inner diameter D4 at the upper end being larger than the inner diameter D5 at the lower end, and can thus avoid dripping of a brazing material during the brazing step. In addition, the flared portion 30 having a shape of spherical zone is less likely to fracture during fabrication. The following describes this effect of avoiding fracture of the flared portion 30 during formation, as well as a method of fabricating the heat exchanger 100, with reference to FIGS. 5 to 18.

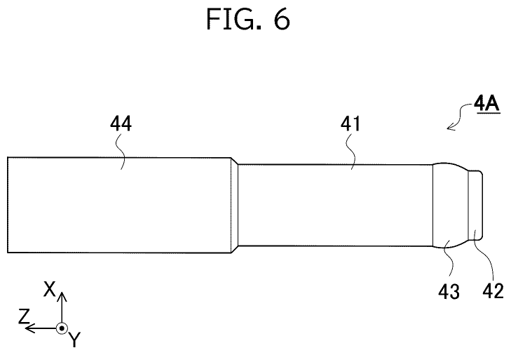

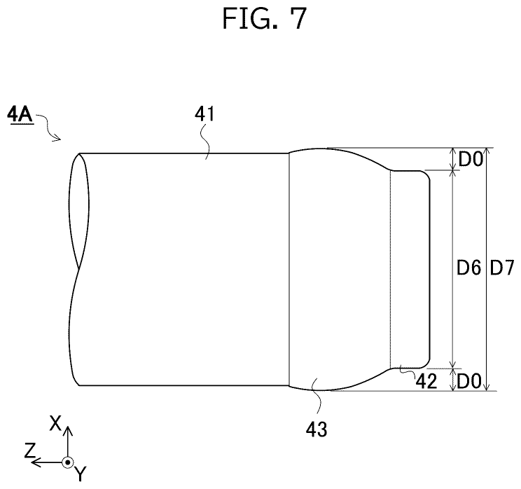

FIG. 5 is a flowchart illustrating the method of fabricating the heat exchanger 100 including the heat transfer pipes 1A according to Embodiment 1. FIG. 6 is a side view of a pipe expanding tool 4A used in the method of fabricating the heat exchanger 100. FIG. 7 is an enlarged view around the tip of the pipe expanding tool 4A.

The method of fabricating the heat exchanger 100 first involves preparing semifinished heat transfer pipes, which are not illustrated, having the above-mentioned hairpin shape and an inner diameter smaller than the above-mentioned inner diameter D1 of the main portion 10 of the heat transfer pipe 1A. The method also involves preparing fins 2 having the above-mentioned shape and size. The fins 2 are arranged in the above-mentioned positional relationship, and fixed to the semifinished heat transfer pipes. These steps produce a heat exchanger core.

The production of a heat exchange core is followed by primary pipe expansion, as illustrated in FIG. 5 (Step S1). In detail, the primary pipe expansion involves inserting a spherical tool having the diameter equal to the above-mentioned inner diameter D1 of the main portion 10, into each of the semifinished heat transfer pipes that constitute the heat exchanger core. The semifinished heat transfer pipes are made of a metal having a high thermal conductivity, like the above-described heat transfer pipes 1A. The semifinished heat transfer pipes, when receiving the above-mentioned spherical tool inserted therein, deform plastically. The spherical tool thus increases the inner diameter and the outer diameter of the semifinished heat transfer pipes.

Although not illustrated, the fins 2 in the heat exchanger core has fin collars, and the semifinished heat transfer pipes are disposed through the fin collars. The primary pipe expansion expands the outer circumferences of the semifinished heat transfer pipes and brings the semifinished heat transfer pipes into close contact with the fin collars. The semifinished heat transfer pipes are thus fixed to the fins 2.

The primary pipe expansion is followed by secondary pipe expansion, as illustrated in FIG. 5 (Step S2). The secondary pipe expansion involves inserting a columnar tool having the outer diameter equal to the above-mentioned inner diameter D3 of the pipe retaining portion 20, into each of the end parts of the semifinished heat transfer pipes expanded in Step S1. This columnar tool is squeezed into the end part by a distance equal to the length of the pipe retaining portion 20. This step yields pipe retaining portions 20 at the end parts of the semifinished heat transfer pipes.

The secondary pipe expansion is followed by formation of the flared portions 30 (Step S3). This step involves expanding the ends of the pipe retaining portions 20 expanded in Step S2 with the pipe expanding tool 4A illustrated in FIG. 6, and thus forming the flared portions 30.

The following describes a structure of the pipe expanding tool 4A. As illustrated in FIGS. 6 and 7, the pipe expanding tool 4A includes a rod 41, and a guide 42 and a spherical segment 43 at the tip or the −Z end of the rod 41. The guide 42 and the spherical segment 43 are arranged in this order from the −Z end.

The +Z end of the rod 41 adjoins a base 44 illustrated in FIG. 6. The base 44 has a male thread for fastening the pipe expanding tool 4A to a driving mechanism of a pipe expanding device, which is not illustrated.

The guide 42 guides the pipe expanding tool 4A, which is inserted from the

+Z end of the pipe retaining portion 20, along the inner wall of the pipe retaining portion 20.

In detail, the guide 42 has a columnar shape having the axis extending in parallel to the Z axis. The guide 42 has a chamfered edge at the −Z end so as to facilitate insertion into the pipe retaining portion 20.

The guide 42 has an outer diameter D6, which is illustrated in FIG. 7, smaller than the inner diameter D3 of the pipe retaining portion 20, which is illustrated in FIG. 3, by a difference that can achieve clearance fit. This structure enables the guide 42, when inserted and squeezed into the pipe retaining portion 20, to move along the inner wall of the pipe retaining portion 20. The outer periphery of the guide 42 abuts on the inner wall of the pipe retaining portion 20, and thus defines the position of the spherical segment 43 adjoining the guide 42 relative to the pipe retaining portion 20. The guide 42 thus achieves proper alignment of the spherical segment 43 of the pipe expanding tool 4A disposed in the pipe retaining portion 20.

The spherical segment 43 serves to form the above-described flared portions 30 of the heat transfer pipes 1A.

In detail, the flared portions 30 each have a shape of spherical zone, as described above. To form such a shape of spherical zone, the spherical segment 43 has a shape of spherical segment that can fit in the spherical-zone shape of the flared portion 30.

This specification defines a spherical segment as a part of a spherical body existing between two parallel planes that intersect the spherical body. Like the above-mentioned spherical surface for defining a spherical zone, examples of the spherical body include elliptical spheres, such as prolate spheres and oblate spheres. The spherical segment may thus have a circular, elliptical, elongated circular, or flattened circular contour, when viewed in the direction orthogonal to the two parallel planes that intersect the spherical body.

The following more specifically describes the shape of the spherical segment 43. As illustrated in FIGS. 6 and 7, the spherical segment 43 has a shape of spherical segment with the outer diameter at the −Z end being smaller than the outer diameter at the +Z end. The outer diameter at the −Z end in this shape of spherical segment is equal to the outer diameter D6 of the guide 42 illustrated in FIG. 7. The outer diameter of the spherical segment 43 gradually increases toward the +Z end in the range from the outer diameter equal to the outer diameter D6. The outer diameter of the spherical segment 43 reaches the maximum outer diameter D7 near the +Z end and then decreases by a certain length.

The outer diameter of the spherical segment 43 at the −Z end has the same dimension as the inner diameter D5 of the flared portion 30 at the −Z end formed by the spherical segment 43. The outer diameter D7 of the thickest part of the spherical segment 43 near the +Z end has the same dimension as the inner diameter D4 of the flared portion 30 at the +Z end. Having the same dimension means being substantially the same diameter including tolerances.

The thickest part of the spherical segment 43 having the outer diameter D7 is thicker than the guide 42. The thickest part preferably has a radius larger than the radius of the guide 42 by a distance DO, which can allow for formation of fillets on the flared portion 30 in the brazing step described below. For example, the distance DO is preferably equal to or shorter than 1 mm. The distance DO preferably has such a length as to allow brazing members to be placed in the brazing step described below, on the flared portion 30 formed by the spherical segment 43. The distance DO is preferably designed not to allow the brazing members to enter the flared portion 30, so as to reduce the percentage of pipe expansion and avoid fracture of the heat transfer pipe 1A.

The spherical segment 43 having such a shape follows the guide 42, which is inserted into the pipe retaining portion 20, and proceeds into the pipe retaining portion 20. The proceeding spherical segment 43 expands the pipe retaining portion 20 and thus forms the above-described flared portion 30.

The spherical segment 43 in this step reduces the value of damage applied to the end part of the pipe retaining portion 20 to be expanded, and thus avoid fracture.

The damage value indicates a value calculated from the Cockcroft-Latham equation represented by Equation (1) below, which is known as a criteria for ductile fracture. A higher damage value indicates a higher probability of fracture of the heat transfer pipe 1A, and a critical damage value indicates occurrence of fracture during pipe expansion.

$$\begin{matrix}[ Equation 1 ] & \\ {D}_{f} = \int ( \frac{{σ}_{max}}{\overline{σ}} ) d ε & ( 1 )\end{matrix}$$

where D_{f} is a damage value, σₘₐₓ is a maximum principal stress, o is an equivalent stress, and de is an increase in equivalent strain.

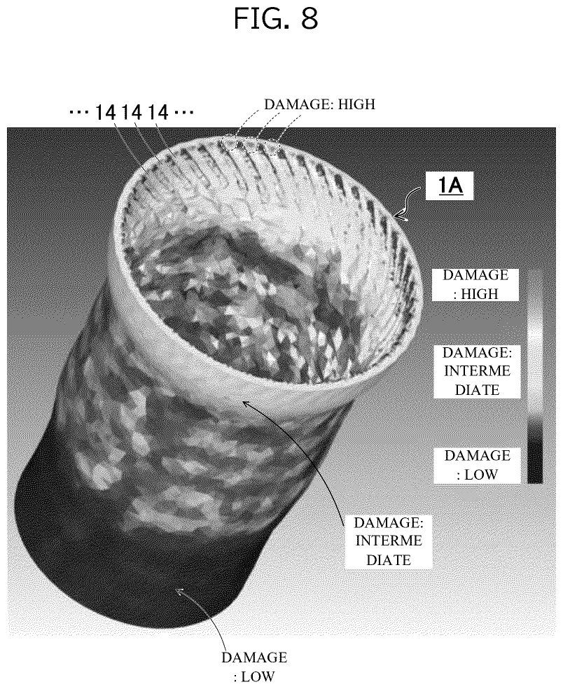

The following describes the effects of the pipe expanding tool 4A for avoiding fracture. FIGS. 8 to 10 illustrate results of simulation for damage values at the heat transfer pipe 1A during formation of the flared portion 30 with the pipe expanding tool 4A.

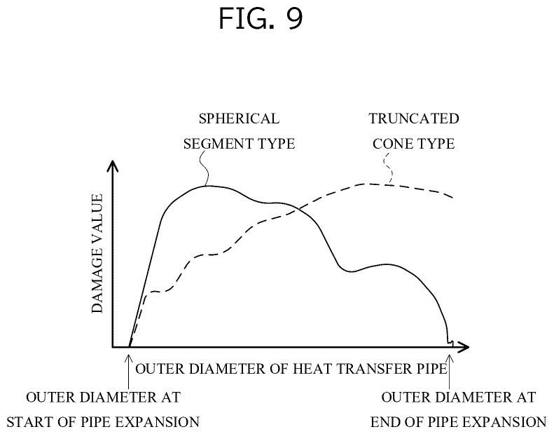

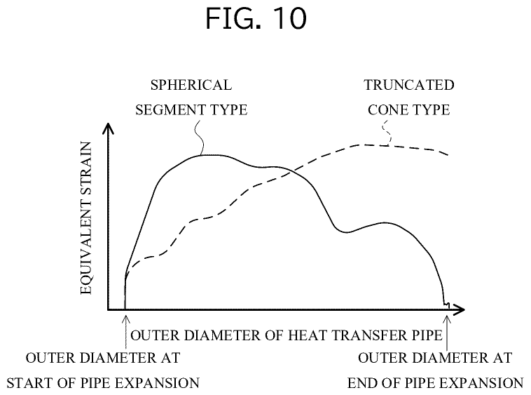

FIG. 8 illustrates a result of simulation for a distribution of damage values at the heat transfer pipe 1A during formation of the flared portion 30 of the heat transfer pipe 1A according to Embodiment 1. FIG. 9 is a graph illustrating an outer diameter of the heat transfer pipe 1A and a damage value during formation of the flared portion 30. FIG. 10 is a graph illustrating a relationship between an outer diameter of the heat transfer pipe 1A and an equivalent strain during formation of the flared portion 30.

FIG. 8 represents damage values of individual sites of the heat transfer pipe 1A with grayscale intensity. FIG. 8 emphasizes only three sites having high damage values in the heat transfer pipe 1A in order to facilitate an understanding, although other sites having high damage values exist along the opening of the end part. FIG. 8 illustrates linear patterns inclined from the open end, which are derived from the above-mentioned spiral grooves 14.

The graphs for a spherical segment type illustrated in FIGS. 9 and 10 correspond to the case of expanding the pipe retaining portion 20 with the pipe expanding tool 4A having the spherical segment 43. The graphs for a truncated cone type corresponds to the case of expanding the pipe retaining portion 20 with a pipe expanding tool having a truncated cone with the side surface curving inward, in place of the spherical segment 43.

FIG. 8 demonstrates that the upper end part, which is expanded during formation of the flared portion 30, has a high damage value. FIG. 9 is a graph illustrating a relationship between a maximum damage value and an outer diameter of the heat transfer pipe 1A during pipe expansion. In the graph for the spherical segment type illustrated in FIG. 9, the damage value rises shortly after an increase in the outer diameter at the start of pipe expansion but then gradually lowers. In contrast, in the graph for the truncated cone type, the damage value continuously rises in accordance with an increase from the outer diameter at the start of pipe expansion. These graphs reveal that the pipe expansion of the pipe retaining portion 20 with the tool of a spherical segment type or the pipe expanding tool 4A is less likely to cause fracture, regardless of a high percentage of pipe expansion.

FIG. 10 demonstrates that the transition of the equivalent strain during pipe expansion has the same tendency as the transition of the damage value. The damage value corresponds to an integrated value of an increase in the equivalent strain, as is apparent from Equation (1). That is, FIG. 10 also reveals that the pipe expansion with the pipe expanding tool 4A is less likely to cause fracture, regardless of a higher percentage of pipe expansion, than the pipe expansion with the pipe expanding tool of a truncated cone type.

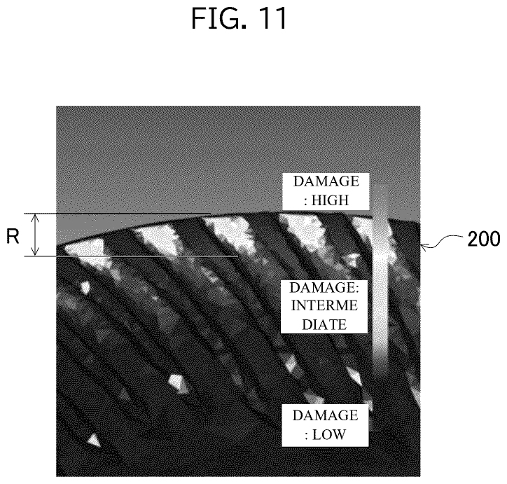

The pipe expanding tool 4A is less likely to cause fracture than the pipe expanding tool of a truncated cone type during pipe expansion. This phenomenon seems to occur because, in the case of pipe expansion with the pipe expanding tool 4A, the sites having high damage values are located inside the end part of the heat transfer pipe 1A. This reason is described below with reference to FIGS. 11 to 14.

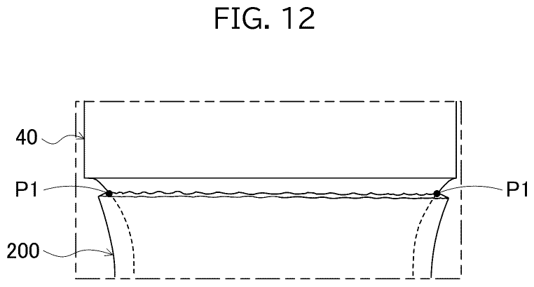

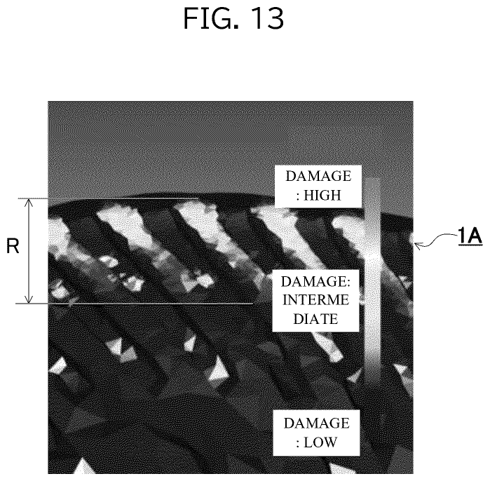

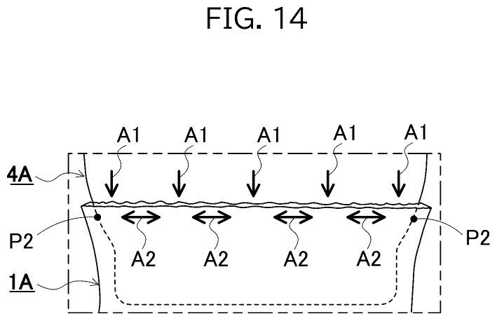

FIG. 11 illustrates a result of simulation for a distribution of damage values at a heat transfer pipe 200 in the case of pipe expansion with a pipe expanding tool 40 of a truncated cone type. FIG. 12 is a front view of the heat transfer pipe 200 according to a reference example in the case of pipe expansion with the pipe expanding tool 40 of a truncated cone type. FIG. 13 illustrates a result of simulation for a distribution of damage values at the heat transfer pipe 1A in the case of pipe expansion with the pipe expanding tool 4A having the spherical segment 43. FIG. 14 is a front view of the heat transfer pipe 1A while being expanded with the pipe expanding tool 4A having the spherical segment 43.

FIG. 11 is a partial enlarged view of an end part of the heat transfer pipe 200 according to the reference example, for facilitation of an understanding. FIG. 13 is also a partial enlarged view of the end part of the heat transfer pipe 1A. FIGS. 12 and 14 illustrate only lateral sites P1 or P2 among the sites existing across the circumference at which the pipe expanding tool 40 comes into contact with the heat transfer pipe 200 or the pipe expanding tool 4A comes into contact with the heat transfer pipes 1A.

As illustrated in FIGS. 11 and 13, the pipe expansion with the pipe expanding tool 4A results in a larger area R illustrated in FIG. 13 having intermediate or high damage values, than the area R illustrated in FIG. 11 resulting from the pipe expansion with the pipe expanding tool 40 of a truncated cone type. This difference is generated because the pipe expanding tool 40 of a truncated cone type continuously comes into contact with the sites P1 near the open end of the heat transfer pipe 200, as illustrated in FIG. 12, during pipe expansion with the pipe expanding tool 40, and causes the stresses to be concentrated near the open end of the heat transfer pipe 200. In contrast, the pipe expanding tool 4A comes into contact with the inner sites P2 distant from the open end of the heat transfer pipe 1A, as illustrated in FIG. 14, during pipe expansion with the pipe expanding tool 4A, and causes the stresses to be spread from the sites near the open end of the heat transfer pipe 1A to the inner sites.

That is, the pipe expanding tool 4A having the spherical segment 43 prevents the stresses from being concentrated at the sites near the open end of the heat transfer pipe 1A, and applies less damage to the heat transfer pipe 1A. The pipe expansion with the pipe expanding tool 4A can therefore avoid fracture of the heat transfer pipe 1A.

The spherical segment 43 of the pipe expanding tool 4A has an outer diameter equal to or larger than the outer diameter of the guide 42, resulting in a step between the guide 42 and the spherical segment 43. This step causes a compressive stress in the end part of the heat transfer pipe 1A as represented by the arrows A1 in FIG. 14, during pipe expansion. The heat transfer pipe 1A is thus expanded as represented by the arrows A2, while receiving this compressive stress.

As is known, a compressive force in a direction different from the direction a tensile force for an intended deformation increases an amount of deformation until fracture. During pipe expansion with the pipe expanding tool 4A, the heat transfer pipe 1A receives a compressive force in the pipe axis direction of the heat transfer pipe 1A, and contemporarily receives a tensile force in the circumferential direction of the heat transfer pipe 1A. This situation can satisfy the above-mentioned relationship between a tensile force and a compressive force, thereby achieving a high equivalent stress.

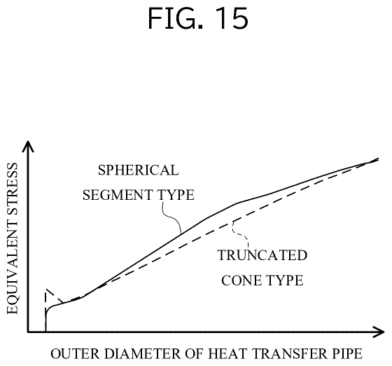

FIG. 15 is a graph illustrating a relationship between a level of pipe expansion and an equivalent stress during formation of the flared portion 30. The graph of FIG. 15 for a spherical segment type and a truncated cone type results from pipe expansion with the tools identical to the tools of a spherical segment type and a truncated cone type applied to the graphs of FIGS. 9 and 10.

Because of satisfaction of the above-mentioned relationship between a tensile force and a compressive force, an equivalent stress in the case of pipe expansion with the tool of a spherical segment type or the pipe expanding tool 4A is higher than the equivalent stress in the case of pipe expansion with the pipe expanding tool 40 of a truncated cone type, as illustrated in FIG. 15. The equivalent stress is a parameter corresponding to the denominator in Equation (1). The damage value represented by Equation (1) in the case of pipe expansion with the pipe expanding tool 4A is accordingly lower than the damage value in the case of pipe expansion with the pipe expanding tool 40 of a truncated cone type.

As described above, the pipe expanding tool 4A has a step between the guide 42 and the spherical segment 43, and can thus reduce the damage value, and avoid fracture of the heat transfer pipe 1A during pipe expansion with the pipe expanding tool 4A.

Furthermore, the spherical segment 43 of the pipe expanding tool 4A has an outer diameter, which increases from the distal end of the tool toward the proximal end opposite to the distal end, once reaches the maximum outer diameter D7, and then decreases by a certain length, as described above. This structure prevents the damage values from being accumulated regardless of a deviation of the distance of squeezing of the pipe expanding tool 4A from a target distance.

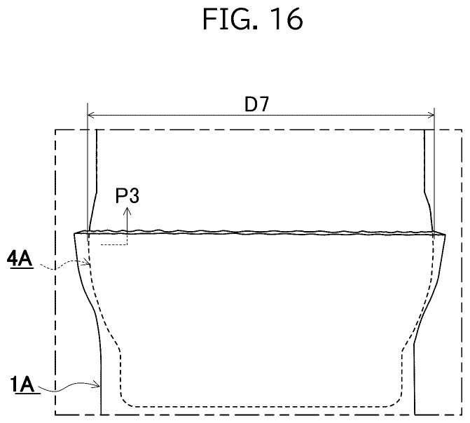

FIG. 16 is a front view of the heat transfer pipe 1A in which the pipe expanding tool 4A having the spherical segment 43 is squeezed by a distance equal to or longer than the target distance. FIG. 16 is an enlarged view of the end part of the heat transfer pipe 1A.

As illustrated in FIG. 16, the squeezing of the pipe expanding tool 4A by a distance equal to or longer than the target distance deforms the heat transfer pipe 1A into a desired inner diameter. The target distance means a value of distance from the distal end of the guide 42 of the pipe expanding tool 4A to the thickest part of the spherical segment 43 having the maximum outer diameter D7. When this pipe expanding tool 4A is squeezed by a distance equal to or longer than the target distance, a part of the pipe expanding tool 4A above the thickest part having the maximum outer diameter D7, that is, the site P3 adjacent to the proximal end is located inside the heat transfer pipe 1A. The outer diameter at the site P3 adjacent to the proximal end of the pipe expanding tool 4A gradually decreases toward the proximal end. This structure can prevent the damage values from being accumulated even when the pipe expanding tool 4A is squeezed by a distance equal to or longer than the target distance, or the distance of squeezing varies among different heat transfer pipes 1A.

That is, the outer diameter of the spherical segment 43 gently decreases at the site P3 more adjacent to the proximal end than the thickest part having the maximum outer diameter D7. This pipe expanding tool 4A can prevent the damage values from being accumulated regardless of a variation in squeezing distance, and avoid fracture of the heat transfer pipe 1A due to pipe expansion with the pipe expanding tool 4A. The pipe expanding tool 4A is less likely to stuck on the inner wall of the heat transfer pipe 1A when extracted from the heat transfer pipe 1A. The pipe expanding tool 4A is thus readily extracted from the heat transfer pipe 1A.

Referring back to FIG. 5, in the formation of the flared portions 30 in Step S3, the ends of the pipe retaining portions 20 of the semifinished heat transfer pipes are expanded with the pipe expanding tool 4A having the above-described structure. In this step, the pipe expanding tool 4A is squeezed until the thickest part having the maximum outer diameter D7 is located inside each of the pipe retaining portions 20. The formed flared portions 30 have a shape of spherical zone. The resulting flared portions 30 each have a thickness decreasing toward the distal end illustrated in FIG. 4 and a chamfered inner edge of the distal end. This step yields the heat transfer pipes 1A having the above-described structure, thereby completing the formation of the flared portion 30.

The formation of the flared portion 30 corresponds to the third pipe expansion in the method of fabricating the heat exchanger 100, and thus is also called tertiary pipe expansion.

As illustrated in FIG. 5, the bent pipes 3 are then fixed to the heat transfer pipes 1A (Step S4). In detail, the fixation of the bent pipes 3 involves inserting the end parts of the bent pipes 3 into the flared portions 30 formed in Step S3, and causes the end parts of the bent pipes 3 to be retained by the pipe retaining portions 20 located deeper than the flared portions 30. This step is conducted for all the heat transfer pipes 1A included in the heat exchanger core. This step completes the fixation of the bent pipes 3.

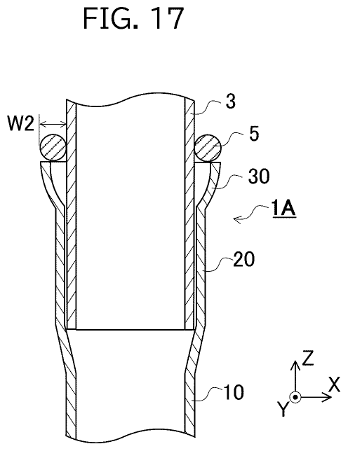

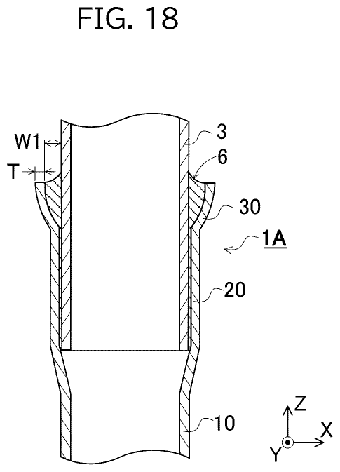

The fixation of the bent pipes 3 is followed by a brazing step (Step S5). The brazing step involves placing brazing members at positions adjacent to the flared portions 30. The brazing members are melted and then provide fillets. This step is described in detail below with reference to FIGS. 17 and 18. The material obtained after melting of brazing members are hereinafter referred to as “brazing material”, in order to facilitate an understanding.

FIG. 17 is a sectional view of the heat transfer pipe 1A provided with brazing members 5 in a brazing step of the method of fabricating the heat exchanger. FIG. 18 is a sectional view of the heat transfer pipe 1A after formation of fillets 6 in the brazing step of the method of fabricating the heat exchanger.

As illustrated in FIG. 17, the brazing members 5 are placed at positions adjacent to the opening of the flared portion 30 in the brazing step, so as to facilitate a brazing material derived from the melted brazing members 5 to enter the flared portion 30. The brazing members 5 placed at these positions are then melted. Then, as illustrated in FIG. 18, the gap between the pipe retaining portion 20 of the heat transfer pipe 1A and the bent pipe 3, and the gap between the flared portion 30 of the heat transfer pipe 1A and the bent pipe 3 are filled with the brazing material. This brazing material provides fillets 6 in a space from the upper end of the flared portion 30 to the outer periphery of the bent pipe 3, that is, a space from the open end of the flared portion 30 to the outer periphery of the bent pipe 3.

The opening of the flared portion 30 has a width W1, which is preferably such a distance as to achieve formation of fillets, for example, a distance equal to or shorter than 1 mm. This structure can enhance the coupling strength between the flared portion 30 and the bent pipe 3. The width W1 of the opening is preferably smaller than a width W2 of the brazing members 5 illustrated in FIG. 17 in the radial direction of the heat transfer pipe 1A. The flared portion 30 having this size can maintain the percentage of pipe expansion during formation as low as possible, and thus avoid fracture of the heat transfer pipe 1A. In this case, the width W1 of the opening of the flared portion 30 is preferably equal to or larger than the half of the width W2 of the brazing members 5, and equal to or smaller than the width W2 of the brazing members 5 by a thickness T of the flared portion 30, in order to achieve placement of the brazing members 5, for example.

After the gap between the heat transfer pipe 1A and the bent pipe 3 is filled with a brazing material in the brazing step, the brazing material is surrounded by the flared portion 30. The brazing material is thus prevented from dripping.

The brazing material, when congealed, fixes the bent pipes 3 to the heat transfer pipes 1A, at the end of the brazing step. The above-described steps complete the method of fabricating the heat exchanger 100, and produce the heat exchanger 100.

The above-mentioned upper end part of the heat transfer pipe 1A is an example of an end part according to the present disclosure. The upper end and the lower end of the flared portion 30 are examples of a distal end and a proximal end of the flared portion 30, respectively, according to the present disclosure. The fixation of the bent pipes 3 is an example of introducing another pipe according to the present disclosure.

As described above, the heat transfer pipes 1A according to Embodiment 1 have the flared portions 30 each having a shape of spherical zone with an inner diameter at the distal end being larger than an inner diameter at the proximal end. This structure can avoid fracture of the flared portion 30 during formation.

The flared portion 30 has the above-mentioned shape of spherical zone, and thus defines a gap broadened toward the distal end of the flared portion 30, against the bent pipe 3 that is a target of coupling. The flared portion 30 can thus readily receive the brazing material located adjacent to the distal end. This flared portion 30 can avoid dripping of a brazing material.

The pipe expanding tool 4A has the spherical segment 43 having a shape of spherical segment with an outer diameter at the distal end being smaller than an outer diameter at the proximal end. The pipe expansion with this pipe expanding tool 4A for fabricating the heat transfer pipe 1A can prevent the stresses from being concentrated at sites near the open end of the heat transfer pipe 1A, and applies less damage to the heat transfer pipe 1A. The resulting heat transfer pipe 1A is thus prevented from fracturing.

The outer diameter of the spherical segment 43 increases from the distal end to the proximal end, reaches the maximum outer diameter, and then decreases by a certain length. This pipe expanding tool 4A, even when squeezed into the heat transfer pipe 1A by a distance equal to or larger than the distance from the distal end of the spherical segment 43 to the thickest part having the maximum outer diameter, does not apply further damage to the heat transfer pipe 1A during pipe expansion. The resulting heat transfer pipe 1A is thus prevented from fracturing.

In addition, the pipe expanding tool 4A has a step between the guide 42 and the spherical segment 43. This step can reduce the damage applied to the heat transfer pipe 1A due to pipe expansion, and prevent the heat transfer pipe 1A from fracturing during pipe expansion.

### EXAMPLES

A pipe expanding tool 4A having the above-described shape was prepared, and applied to an examination for expansion of a circular copper pipe having a thickness of 0.17 mm. This examination involved: (1) pipe expansion in which the pipe expanding tool 4A was squeezed at a speed of 0.1 mm/s by a distance of 3.5 mm; and (2) pipe expansion in which the pipe expanding tool 4A was squeezed at a speed of 20 mm/s by a distance of 3.5 mm. The examination also involved, as comparative examples, pipe expansion under each of the above-mentioned conditions, with a pipe expanding tool 40 of a truncated cone type described above with reference to FIG. 12. The pipe expansion was followed by inspection whether any fracture occurs in the expanded copper pipes. The copper pipes free from fracture were further inspected for a buckling phenomenon. The results of the inspections are listed in Table 1. Table 1 refers to the pipe expanding tool 4A as “spherical segment type”, and refers to the pipe expanding tool 40 as “truncated cone type”.

TABLE 1

| | | | | Number of |
|---|---|---|---|---|
| | | | Number of | buckling |
| | Speed of | Pipe | fractures/ | phenomena/ |
| | insertion | expanding | Total | Total |
| | [mm/s] | tool | number | number |
| Example 1 | 0.1 | Spherical | 3/5 | 0/5 |
| | | segment type | | |
| Example 2 | 20.0 | Spherical | 3/5 | 0/5 |
| | | segment type | | |
| Comparative | 0.1 | Truncated cone | 3/5 | 2/5 |
| Example 1 | | type | | |
| Comparative | 20.0 | Truncated cone | 5/5 | — |
| Example 2 | | type | | |

Table 1 demonstrates that the pipe expansion with the pipe expanding tool of a spherical segment type or the pipe expanding tool 4A less readily caused fracture of a copper pipe and less readily caused a buckling phenomenon that may lead to fracture of the copper pipe, than the pipe expansion with the pipe expanding tool of a truncated cone type or the pipe expanding tool 40. The pipe expanding tool 4A, even when squeezed at an increased speed, less readily caused fracture of a copper pipe and thus achieved high efficiency of pipe expansion. That is, the pipe expanding tool 4A is less likely to cause fracture of a copper pipe during pipe expansion, and can achieve high efficiency of pipe expansion.

### Embodiment 2

In Embodiment 1, the pipe expanding tool 4A has the guide 42 and the spherical segment 43, and the guide 42 and the spherical segment 43 are arranged in this order from the distal end.

This pipe expanding tool 4A is, however, a mere example. The pipe expanding tool 4A is only required to have a spherical segment 43 with an outer diameter at the distal end being smaller than an outer diameter at the proximal end and the distal end having a size at which the distal end is insertable into the end part of the heat transfer pipe 1A. The spherical segment 43 is inserted into the end part of the heat transfer pipe 1A, such that the spherical segment 43 from the distal end to the proximal end is disposed inside the end part, thereby forming the flared portion 30. In other words, the pipe expanding tool 4A may have a structure other than the spherical segment 43.

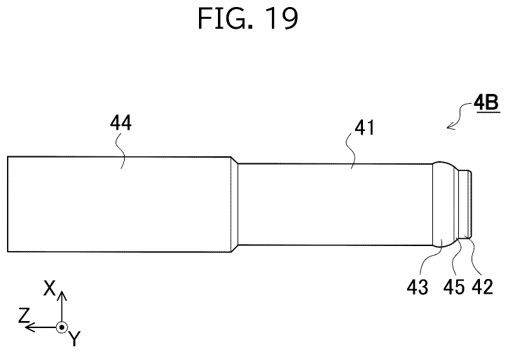

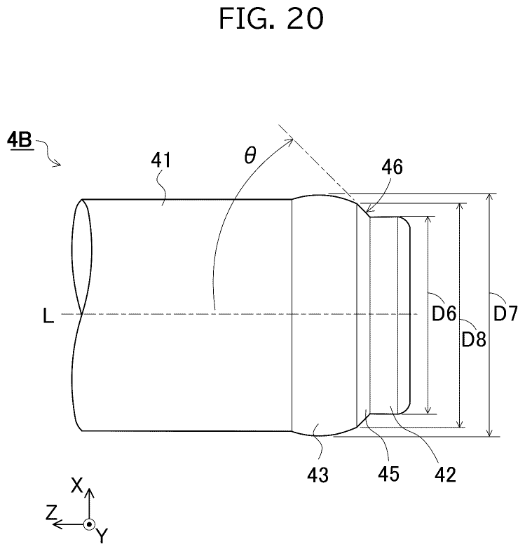

A pipe expanding tool 4B according to Embodiment 2 has a truncated cone 45, in addition to the guide 42 and the spherical segment 43. The following describes the pipe expanding tool 4B according to Embodiment 2, with reference to FIGS. 19 and 20. The description of Embodiment 2 is mainly directed to the differences from Embodiment 1.

FIG. 19 is a side view of the pipe expanding tool 4B. FIG. 20 is an enlarged view around the tip of the pipe expanding tool 4B.

As illustrated in FIGS. 19 and 20, the pipe expanding tool 4B has the truncated cone 45 disposed between the guide 42 and the spherical segment 43.

The truncated cone 45 has a shape of truncated cone oriented such that the smaller base faces the guide 42 and the larger base faces the spherical segment 43. As illustrated in FIG. 20, the truncated cone 45 has an outer diameter increasing from the guide 42 toward the spherical segment 43, that is, in the +Z direction, in the range from the outer diameter equal to the outer diameter D6 of the guide 42 to the outer diameter equal to the minimum outer diameter D8 of the spherical segment 43 at the −Z end. The truncated cone 45 thus has an inclined surface 46 inclined from the central axis L. In contrast to Embodiment 1 in which the heat transfer pipe 1A receives a compressive force in the pipe axis direction and receives a tensile force in the circumferential direction during pipe expansion with the pipe expanding tool 4A and thus achieves a higher equivalent stress, the inclined surface 46 varies the direction and magnitude of this compressive force. The inclined surface 46 can accordingly reduce the damage applied to the heat transfer pipe according to Embodiment 2 during pipe expansion with the pipe expanding tool 4B.

The inclined surface 46 forms an angle θ from the central axis L, which is preferably equal to or larger than 40° and smaller than 60°. A typical example of the angle θ is 45°. Such a range of angle θ can reduce the damage value described in Embodiment 1 while avoiding a buckling phenomenon.

The above-described truncated cone 45 is an example of frustum according to the present disclosure.

As described above, the pipe expanding tool 4B according to Embodiment 2 has the truncated cone 45 adjacent to the −Z end or the distal end of the spherical segment 43. The truncated cone 45 has a shape of frustum having an outer diameter decreasing toward the distal end. The pipe expanding tool 4B thus turns the direction of a compressive force applied to the heat transfer pipe according to Embodiment 2 to a specific direction during pipe expansion, and adjusts the magnitude of the compressive force in the specific direction, thereby reducing the damage applied to the heat transfer pipe according to Embodiment 2. The pipe expanding tool 4B can therefore avoid fracture of the heat transfer pipe according to Embodiment 2.

The above-described heat transfer pipe 1A, heat exchanger 100, pipe expanding tools 4A and 4B, pipe expanding device, method of coupling the heat transfer pipe 1A to another pipe, and method of fabricating the heat exchanger 100 according to the embodiments of the present disclosure are mere examples. The heat transfer pipe 1A, heat exchanger 100, pipe expanding tools 4A and 4B, pipe expanding device, method of coupling the heat transfer pipe 1A to another pipe, and method of fabricating the heat exchanger 100 may have other configurations.

For example, although the heat transfer pipe 1A is the target of coupling to the bent pipe 3 in Embodiment 1, the target of coupling to the heat transfer pipe 1A is not limited to the bent pipe 3. The target of coupling to the heat transfer pipe 1A is only required to be a pipe. For example, the target of coupling may be a pipe for connecting the heat exchanger 100 to an external apparatus, or a refrigerant pipe. The target of coupling is a pipe having any shape. That is, the target of coupling may be a pipe other than the circular pipe.

Although the heat transfer pipe 1A is a circular pipe or a pipe having a circular section in Embodiments 1 and 2, the heat transfer pipe 1A may have another structure. The heat transfer pipe 1A is only required to have a flared portion 30 that has a shape of spherical zone with an inner diameter at the distal end being larger than an inner diameter at the proximal end and that is disposed with a pipe that is the target of coupling being disposed through the flared portion 30. Furthermore, the flared portion 30 is only required to be coupled to another pipe with a brazing material filling a gap between the other pipe and an inner wall of the flared portion 30. The heat transfer pipe 1A may have any shape provided that the heat transfer pipe 1A satisfies these conditions. That is, the heat transfer pipe 1A may have a flattened circular section.

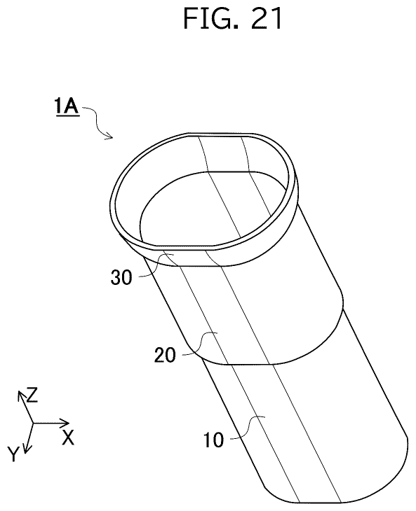

FIG. 21 is a perspective view of a modification of the heat transfer pipe 1A according to Embodiment 1.

As illustrated in FIG. 21, the heat transfer pipe 1A may also be a flat pipe having an elongated circular section. In this case, the flared portion 30 preferably has a shape of spherical zone existing between two parallel planes that intersect a spherical surface of a prolate sphere in the long radius direction. In order to form such a flared portion 30, the spherical segment 43 of the pipe expanding tool 4A or 4B preferably has a shape of spherical segment existing between the same two parallel planes that intersect a spherical body of the same prolate sphere in the long radius direction.

Although the heat transfer pipe 1A has the spiral grooves 14 therein in Embodiments 1 and 2, the heat transfer pipe 1A may have another structure. As described above, the heat transfer pipe 1A is only required to have the flared portion 30 that has a shape of spherical zone with an inner diameter at the distal end being larger than an inner diameter at the proximal end and that is disposed with a pipe that is the target of coupling being disposed through the flared portion 30. In addition, the flared portion 30 is only required to be coupled to another pipe with a brazing material filling a gap between the other pipe and an inner wall of the flared portion 30. That is, the heat transfer pipe 1A may have any internal structure, that is, any shape of flow path.

For example, the heat transfer pipe 1A may have parallel grooves extending in parallel to the pipe axis direction on the inner wall. In general, a heat transfer pipe 1A having grooves, such as spiral grooves 14 or parallel grooves, readily fractures during pipe expansion. In contrast, the heat transfer pipe 1A has the above-described flared portion 30 and is thus prevented from fracturing during pipe expansion. Alternatively, the heat transfer pipe 1A may have a smooth inner wall without grooves.

The flared portion 30 is disposed at the upper end part of the heat transfer pipe 1A in Embodiments 1 and 2, but may be disposed at any end of the heat transfer pipe 1A provided that the fared portion 30 satisfies the above-described requirements. In an exemplary case of the heat transfer pipe 1A extending in the horizontal direction, the flared portion 30 may be disposed at the right or left end of the heat transfer pipe 1A.

Although the pipe expanding tools 4A and 4B each have the guide 42 in Embodiments 1 and 2, the pipe expanding tools 4A and 4B may have another structure. The pipe expanding tools 4A and 4B are each only required to have the spherical segment 43 with an outer diameter at the distal end being smaller than an outer diameter at the proximal end and the distal end having a size at which the distal end is insertable into the end part of the heat transfer pipe 1A. In addition, the spherical segment 43 is inserted into the end part of the heat transfer pipe 1A, such that the spherical segment 43 from the distal end to the proximal end is disposed inside the end part, thereby forming the flared portion 30. The pipe expanding tools 4A and 4B may include or exclude the guide 42 provided that the pipe expanding tools 4A and 4B satisfy these conditions.

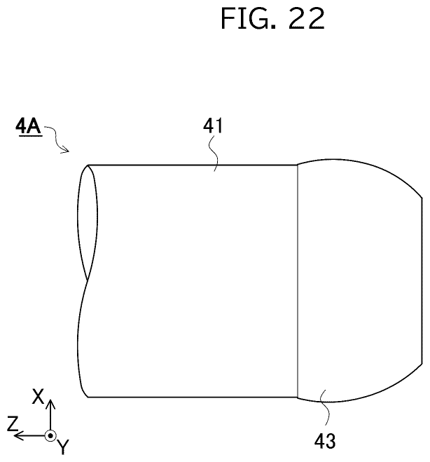

FIG. 22 is a side view of a modification of the pipe expanding tool 4A. FIG. 22 illustrates only a part around the tip of the modification of the pipe expanding tool 4A.

As illustrated in FIG. 22, the pipe expanding tool 4A may have the spherical segment 43 alone at the distal end of the rod 41. The pipe expanding tool 4A having such a structure can also form the flared portion 30 having the above-described shape, and avoid fracture of the heat transfer pipe 1A during formation.

Although the outer diameter of the spherical segment 43 of the pipe expanding tool 4A increases toward the proximal end opposite to the distal end, reaches the maximum outer diameter D7, and then decreases by a certain length in Embodiments 1 and 2, the spherical segment 43 may have another structure. The spherical segment 43 is only required to have an outer diameter at the distal end smaller than an outer diameter at the proximal end, and have the distal end having a size at which the distal end is insertable into the end part of the heat transfer pipe 1A. That is, the spherical segment 43 does not necessarily decrease by a certain length after reaching the maximum outer diameter near the proximal end. The outer diameter of the spherical segment 43 may also reach the maximum outer diameter at the proximal end. This modified pipe expanding tool 4A can still avoid fracture of the heat transfer pipe 1A during pipe expansion, although the modified pipe expanding tool 4A can be less readily extracted from the heat transfer pipe 1A after pipe expansion, than the original pipe expanding tool 4A, in which the outer diameter of the spherical segment 43 reaches the maximum outer diameter near the proximal end and then decreases by a certain length.

The pipe expanding tools 4A and 4B may also be called punches. The pipe expanding tools 4A and 4B may each be fastened to a pipe expanding device, including a driving mechanism that can retain the rod 41 and shift the rod 41 in its axial direction.

As described above, the above-described embodiments are mere examples of the heat transfer pipe 1A, heat exchanger 100, pipe expanding tools 4A and 4B, pipe expanding device, method of coupling the heat transfer pipe 1A to another pipe, and method of fabricating the heat exchanger 100. The embodiments may allow for various modifications and replacements. The following describes various modes of the present disclosure in the form of appendixes.

### Appendix 1

A heat transfer pipe, including:
a flared portion having a shape of spherical zone with an inner diameter at a distal end being larger than an inner diameter at a proximal end, the flared portion being disposed with another pipe that is a target of coupling being disposed through the flared portion, wherein
the flared portion is coupled to the other pipe with a brazing material filling a gap between the other pipe and an inner wall of the flared portion.

### Appendix 2

The heat transfer pipe according to Appendix 1, wherein the flared portion has, at an inner site adjacent to the distal end, a fillet made of the brazing material.

### Appendix 3

The heat transfer pipe according to Appendix 1 or 2, wherein the flared portion has, at the distal end, a chamfered edge adjacent to the inner wall.

### Appendix 4

The heat transfer pipe according to Appendix 3, wherein the flared portion has a thickness decreasing from the proximal end toward the distal end.

### Appendix 5

The heat transfer pipe according to any one of Appendixes 1 to 4, wherein the flared portion has spiral grooves on the inner wall.

### Appendix 6

A heat exchanger, including:
a plurality of the heat transfer pipes according to any one of Appendixes 1 to 5;
fins attached to the heat transfer pipes; and
the other pipe.

### Appendix 7

A pipe expanding tool for forming, at an end part of a heat transfer pipe, a flared portion for another pipe that is a target of coupling, the other pipe being to be disposed through the flared portion, the pipe expanding tool including:
a spherical segment with an outer diameter at a distal end being smaller than an outer diameter at a proximal end, the distal end of the spherical segment having a size at which the distal end is insertable into the end part of the heat transfer pipe, wherein
inserting the spherical segment into the end part of the heat transfer pipe such that the spherical segment from the distal end to the proximal end is disposed inside the end part forms the flared portion.

### Appendix 8

The pipe expanding tool according to Appendix 7, wherein the spherical segment has, between the distal end and the proximal end, a part having an outer diameter larger than the outer diameter at the proximal end.

### Appendix 9

The pipe expanding tool according to Appendix 7 or 8, further including:
a frustum disposed adjacent to the distal end of the spherical segment, the frustum having an outer diameter decreasing toward a distal end of the frustum, the outer diameter at a proximal end of the frustum being equal to the outer diameter of the spherical segment at the distal end.

### Appendix 10

The pipe expanding tool according to any one of Appendixes 7 to 9, further including:

a guide disposed adjacent to the distal end of the spherical segment, the guide being capable of fitting in an inner periphery of the end part of the heat transfer pipe.

### Appendix 11

The pipe expanding tool according to any one of Appendixes 7 to 10, wherein an outer diameter of the spherical segment has a dimension that is a same as a dimension of an inner diameter of the flared portion.

### Appendix 12

A pipe expanding device, including:
the pipe expanding tool according to any one of Appendixes 7 to 11; and
a driving mechanism for squeezing the spherical segment of the pipe expanding tool into the heat transfer pipe.

### Appendix 13

A method of coupling a heat transfer pipe to another pipe, for coupling an end part of a heat transfer pipe to another pipe that is a target of coupling, the method including:
forming a flared portion at the end part by inserting the spherical segment of the pipe expanding tool according to any one of Appendixes 7 to 11 into the end part of the heat transfer pipe, such that the spherical segment from the distal end to the proximal end is disposed inside the end part;
introducing the other pipe into the flared portion; and
coupling the heat transfer pipe to the other pipe by filling a gap between an inner wall of the flared portion and the other pipe with a brazing material.

### Appendix 14

The method of coupling a heat transfer pipe to another pipe according to Appendix 13, wherein the coupling of the heat transfer pipe to the other pipe includes
placing, at a distal end of the flared portion, brazing members that are larger than the gap between the inner wall of the flared portion and the other pipe,
melting the brazing members, and
filling the gap with the melted brazing members.

### Appendix 15

A method of fabricating a heat exchanger, the method including the method of coupling a heat transfer pipe to another pipe according to Appendix 13 or 14.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full area of equivalents to which such claims are entitled.

This application claims the benefit of Japanese Patent Application No. 2022-80337, filed on May 16, 2022, the entire disclosure of which is incorporated by reference herein.

### REFERENCE SIGNS LIST

1A Heat transfer pipe
2 Fin
3 Bent pipe
4A, 4B Pipe expanding tool
5 Brazing member
6 Fillet
10 Main portion
11, 12 Linear segment
13 Curved segment
14 Spiral groove
20 Pipe retaining portion
30 Flared portion
40 Pipe expanding tool
41 Rod
42 Guide
43 Spherical segment
44 Base
45 Truncated cone
46 Inclined surface
100 Heat exchanger
200 Heat transfer pipe
A1, A2 Arrow
D0 Distance
D1 Inner diameter
D2 Outer diameter
D3-D5 Inner diameter
D6-D8 Outer diameter
L Central axis
P1-P3 Site
R Area
T Thickness
W1, W2 Width
θ Angle

1. A heat transfer pipe, comprising:
a flared portion having a shape of spherical zone having a proximal end and a distal end with (i) an inner diameter increasing toward the distal end and (ii) the inner diameter at the distal end being larger than the inner diameter at the proximal end, the flared portion being disposed with another pipe that is a target of coupling being disposed through the flared portion; and
a pipe retaining portion that disposed at the proximal end of the flared portion and receives an end of the another pipe, wherein
each of the flared portion and the pipe retaining portion has an inner wall coupled to the another pipe with a brazing material.

2. The heat transfer pipe according to claim 1, wherein the flared portion has, at an inner site adjacent to the distal end, a fillet made of the brazing material.

3. The heat transfer pipe according to claim 1, wherein the flared portion has, at the distal end, a chamfered edge adjacent to the inner wall.

4. The heat transfer pipe according to claim 3, wherein the flared portion has a thickness decreasing from the proximal end toward the distal end.

5. The heat transfer pipe according to claim 1, wherein the flared portion has spiral grooves on the inner wall.

6. A heat exchanger, comprising:
a plurality of the heat transfer pipes according to claim 1;
fins attached to the heat transfer pipes; and
the another pipe.

7-9. (canceled)

10. A pipe expanding tool for forming, at an end part of a heat transfer pipe, a flared portion for another pipe that is a target of coupling, the another pipe being to be disposed through the flared portion, the pipe expanding tool comprising:
a spherical segment with an outer diameter at a distal end being smaller than an outer diameter at a proximal end, the distal end of the spherical segment having a size at which the distal end is insertable into the end part of the heat transfer pipe, wherein
inserting the spherical segment into the end part of the heat transfer pipe such that the spherical segment from the distal end to the proximal end is disposed inside the end part forms the flared portion, and
the pipe expanding tool further includes a guide disposed adjacent to the distal end of the spherical segment, the guide being capable of fitting in an inner periphery of the end part of the heat transfer pipe.

11. The pipe expanding tool according to claim 10, wherein an outer diameter of the spherical segment has a dimension that is a same as a dimension of an inner diameter of the flared portion.

12. A pipe expanding device, comprising:
the pipe expanding tool according to claim 10; and
a driving mechanism for squeezing the spherical segment of the pipe expanding tool into the heat transfer pipe.

13. A method of coupling a heat transfer pipe to another pipe, for coupling an end part of a heat transfer pipe to another pipe that is a target of coupling, the method comprising:
forming a flared portion at the end part by inserting the spherical segment of the pipe expanding tool according to claim 10 into the end part of the heat transfer pipe such that the spherical segment from the distal end to the proximal end is disposed inside the end part;
introducing the another pipe into the flared portion; and
coupling the heat transfer pipe to the another pipe by filling a gap between an inner wall of the flared portion and the another pipe with a brazing material.

14. The method of coupling a heat transfer pipe to another pipe according to claim 13, wherein the coupling of the heat transfer pipe to the another pipe includes
placing, at a distal end of the flared portion, brazing members that are larger than the gap between the inner wall of the flared portion and the another pipe,
melting the brazing members, and
filling the gap with the melted brazing members.

15. A method of fabricating a heat exchanger, the method comprising the method of coupling a heat transfer pipe to another pipe according to claim 13.

16. The method of coupling a heat transfer pipe to another pipe according to claim 14, wherein a width of the gap between the inner wall of the flared portion and the another pipe is smaller than a width of the brazing members in a radial direction of the another pipe.

17. The pipe expanding tool according to claim 10, wherein the spherical segment has, between the distal end and the proximal end, a part having an outer diameter larger than the outer diameter at the proximal end.

18. The pipe expanding tool according to claim 10, further comprising:
a frustum disposed adjacent to the distal end of the spherical segment, the frustum having an outer diameter decreasing toward a distal end of the frustum, the outer diameter at a proximal end of the frustum being equal to the outer diameter of the spherical segment at the distal end.

19. A heat transfer pipe, comprising:
a flared portion having a shape of spherical zone having a proximal end and a distal end with (i) an inner diameter increasing toward the distal end and (ii) the inner diameter at the distal end being larger than the inner diameter at the proximal end, a thickness at the distal end at which the inner diameter is largest being smaller than a thickness at the proximal end, the flared portion being disposed with another pipe that is a target of coupling being disposed through the flared portion, wherein
the flared portion is coupled to the another pipe with a brazing material filling a gap between the another pipe and an inner wall of the flared portion.
